(19) United States
(12) Patent Application Publication
(10) Pub. No.: US 2024/0193743 A1
(43) Pub. Date: Jun. 13, 2024

(54) METHOD FOR REDUCING A TEMPORAL NOISE IN AN IMAGE SEQUENCE OF A CAMERA

(71) Applicant: Connaught Electronics Ltd., Tuam (IE)

(72) Inventors: Emre TURGAY, Tuam (IE); Barry DEVER, Tuam (IE); Mark Patrick GRIFFIN, Troy, MI (US); Jonathan HORGAN, Tuam (IE)

(73) Assignee: Connaught Electronics Ltd., Tuam (IE)

(21) Appl. No.: 18/064,739

(22) Filed: Dec. 12, 2022

(51) Int. Cl. G06T 5/00; G06T 5/50; G06T 7/254

(52) U.S. Cl. CPC G06T 5/002; G06T 5/50; G06T 7/254; G06T 2207/10016; G06T 2207/20224; G06T 2207/30252

(57) ABSTRACT

A method for reducing temporal noise in an image sequence by a camera of an assistance system of a motor vehicle by an electronic computing device. The method includes capturing a first image and a second image of the image sequence of an environment of the motor vehicle by the camera at a first point and a second point in time. Furthermore, determining at least one feature in the second image and determining of pixels associated with the at least one feature in the second image by the feature capturing module. Moreover, generating a weighting map comprising a weight value for each pixel of the second image by an adaptive motion estimation module. Lastly, reducing the temporal noise by blending pixels of the first image with pixels of the second image in dependence on the generated weighting map by a blending module.

### TECHNICAL FIELD

The invention relates to a method for reducing a temporal noise in an image sequence of a camera of an assistance system of a motor vehicle by an electronic computing device. Further, the invention relates to a computer program product, a computer-readable storage medium as well as an electronic computing device.

### BACKGROUND OF THE INVENTION

Temporal noise is a common problem in Image capturing devices. This random noise, which varies from frame to frame especially amplifies with low light, such as night or poorly illuminated indoor conditions. There is an extensive literature on video denoising techniques to remove temporal noise. These techniques are classified under the category of temporal filtering.

In particular the temporal filtering relates to the filtering of video sequences, that is in particular of images strung together (image sequence), along a timeline, to remove noise, which may occur in poorly illuminated scenes. In this connection filtering can be implemented in both recursive and non recursive manner. A recursive temporal filtering takes place, wherein an already filtered image is fed back again, and this, in turn, is blended with a newly taken image. Moreover, also a non-recursive filtering is known, in which two or more unfiltered images at successive time instances may be blended with each other. These approaches are in particular sufficient in the case of a stationary scenario. If, however, for instance a camera platform moves or moving objects are present in the scene, a motion blur artifact occurs, which is also known as a so-called ghosting artifact.

### SUMMARY OF THE INVENTION

It is the objective of the present invention to provide a method, a computer program product, a computer-readable storage medium as well as an electronic computing device, by which an improved reduction of temporal noise of an image sequence of a camera is facilitated.

This objective is solved by a method, a computer program product, a computer-readable storage medium as well as an electronic computing device.

One aspect of the invention relates to a method for reducing temporal noise of an image sequence of a camera of an assistance system of a motor vehicle by an electronic computing device of the assistance system. A first image of the image sequence in an environment of the motor vehicle is captured by the camera at a first point in time and a second image of the image sequence of the environment is captured by the camera at a second point in time that is later than the first point in time. At least one feature in the second image is determined by a feature capturing module of the electronic computing device. At least one pixel associated with at least one feature in the second image is determined by the feature capturing module. In particular, a plurality of associated pixels is determined. A weighting map for each pixel of the image is generated by an adaptive motion estimation module of the electronic computing device. The temporal noise is reduced by blending pixels of the first image with pixels of the second image in dependence on the generated weighting map by a blending module of the electronic computing device.

Thus, in particular a method and a system for removing temporal noise in video sequences is suggested. In particular a motion-adaptive method for temporal filtering is suggested. The pixels in motion are exempted from blending by an adaptive motion detector. The motion detector uses a target image, that is the second image, a previous filtered image, that is the first image, and object features in order to control the sensitivity of motion detection. The present invention aims at the reduction of the temporal noise, in particular in poor light conditions, where the temporal noise in comparison with the real object features is high.

In particular it may for instance be envisaged that in the weighting map a 1 stands for pixels in motion and an alpha for stationary pixels. If a pixel is stationary, it is superimposed or blended, otherwise the pixel from the target image is maintained. Similar to standard temporal filtering, this approach may be implemented either recursively or non-recursively. This approach is in particular especially simple and very efficient and may be used in embedded platforms, where memory and processing power is invariably required, for instance in the case of vision system applications in the automotive industry. Thus, in particular for instance the provided assistance system may be used as vision system application, for instance as a surround view application in the motor vehicle.

The sensitivity of motion detection is improved by the use of a set of image features detected by a feature capturing module.

There are in particular two kinds of errors in the motion estimation phase. The first error is the marking of a pixel as stationary, even though it is a pixel in motion. The second error is the marking of a pixel as a pixel in motion, even though it is stationary. Falsely marking a pixel as stationary leads to motion blur in the image. Falsely marking a pixel as non-stationary leads to visible temporal noise in uniform places in the image. The method presented here solves this problem reliably.

According to an advantageous embodiment, pixels, which are determined to be stationary, in the second image are blended. In particular the feature capturing module generates a set of feature points. An adaptive motion detector generates a weighting map, which is used for the superimposition or blending. The weighting map consists of weighting values between alpha and 1. Alpha therein marks a stationary pixel and 1 marks for instance a moving pixel. These weightings are determined in the adaptive motion detection block, in particular the electronic computing device, on the basis of the pixel-by-pixel difference between the current, that is the second image, and the previous image, that is the first image, and the feature point set computed in the feature capturing module. Essential to the invention is in this connection the determination of the threshold value for each pixel difference value on the basis of the proximity of its coordinates to the feature point set.

Furthermore, the threshold for each pixel difference value is set to a lower value if it is within a close distance to a feature point. Lower threshold value refers to a higher chance of marking the corresponding pixel as a moving pixel. This approach increases the chance of marking pixels close to feature points as moving pixels. Thereby motion-blur artifacts in the blended image can be mitigated, whereby an improved reduction of a temporal noise can be realized.

In a further advantageous embodiment the first image is blended with a further image that has been taken already before the first image. Thus, in particular the first image is an already blended image. The first image therein may have been blended according to the same method as the second image. Thus, in particular this embodiment is a recursive method for noise reduction.

Further, it has proven to be advantageous, if the first image is provided as an unblended image. In other words, the first image is not processed and thus not provided as a filtered image. In this embodiment thereby a non-recursive method is presented.

The foregoing elements and features may be combined in various combinations without exclusivity, unless expressly indicated otherwise. These elements and features, as well as the operation thereof, will become more apparent in view of the following detailed description with accompanying drawings. It should be understood that the following detailed description and accompanying drawings are intended to be exemplary in nature and non-limiting.

### BRIEF DESCRIPTION OF DRAWINGS

The embodiments of the present disclosure are pointed out with particularity in the appended claims. Various other features will become more apparent to those skilled in the art from the following detailed description of the disclosed non-limiting embodiments and will be best understood by referring to the following detailed description along with the accompanying drawings in which:

FIG. 1 illustrates a schematic top view of an embodiment of a motor vehicle with an embodiment of an assistance system with an embodiment of an electronic computing unit;

FIG. 2 illustrates a schematic block diagram according to an embodiment of the electronic computing device;

FIG. 3 illustrates a further schematic block diagram according to a further embodiment of the electronic computing device;

FIG. 4 illustrates a further schematic block diagram according to an embodiment of the electronic computing device;

FIG. 5 illustrates a still further schematic block diagram according to an embodiment of the electronic computing device;

FIG. 6a and FIG. 6b illustrate schematic diagrams for determining a weighting factor according to an embodiment of the invention; and

FIG. 7 illustrates a method for reducing a temporal noise in an image sequence by a camera of an assistance system of a motor vehicle by an electronic computing device of the assistance system.

### DETAILED DESCRIPTION OF THE INVENTION

Detailed embodiments of the present invention are disclosed herein. It is to be understood that the disclosed embodiments are merely examples of the invention that may be embodied in various and alternative forms. The Figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features described and illustrated with reference to any one of the Figures can be combined with features illustrated in one or more other Figures to produce embodiments that are not explicitly described or illustrated. The combinations of features illustrated provide representative embodiments for typical applications. However, various modifications and combinations of the features consistent with the teachings of this disclosure may be desired for particular applications or implementations.

In a further advantageous embodiment, the at least one feature is determined on the basis of a feature search, in particular a corner search, in the second image. Herein in particular a so-called SIFT method is used. The SIFT method (Scale-invariant Feature Transform) is an algorithm for the detection and description of local features in images. This detector and the feature descriptions are, in particular within certain boundaries, invariant towards coordinate transformations, such as translation, rotation, and scaling. In particular on the basis of the SIFT method a search for key points as features in the image can be reliably performed.

Alternatively or additionally, it is to be noted that also other feature detectors may be used in order to be able to perform the corresponding feature detection. For instance, also an external object detection or a tracking system in a surround-view system in the motor vehicle may be used to be able to perform the corresponding feature extraction. Further, also a bicycle detection or a pedestrian detection can be used for feature capturing. At this point, it is to be remarked that this is purely exemplary and by no means conclusive. Also further feature detections may be used to be capable of being used for noise reduction.

It has further proven to be advantageous, if the determining of the motion is performed on the basis of a subtraction of the first image and the second image. In particular this filter attempts to identify areas of movement activity within the sequence, by comparing the similarity between pixels of the current and previous frames. The sum of absolute difference (SAD) is used in particular within this invention as a similarity measure. Alternatively, it is to be noted that other similarity metrics, for instance, sum of square difference may also be used in order to obtain a similarity measure. At this point, it is to be remarked that this is purely exemplary and by no means conclusive. If a particular pixel has high motion, then the similarity between the current pixel and co-located pixel in the previous frame would be low, which leads SAD values higher which eventually leads to the lower possibility of blending with previous frames. In particular, an average SAD within a local window is calculated to increase the robustness of the similarity metric for each pixel. A so-called average strength for the difference pixel is determined in a local window by the following formula:

$$D ( x , y ) = {\sum }_{i = - M}^{M} {\sum }_{j = - M}^{M} ‖ {F}_{t} ( x - i , y - j ) - {G}_{t - 1} ( x - i , y - j ) ‖$$

The above formula is simplified to contain only the luma component of the incoming video. It will be obvious for those skilled in the art that this can be extended for a three channel video sequence in which each pixel is composed of red, green and blue channels in RGB format or luma and chrominance values in YUV format. In particular for a three channel extension of the above equation: the square sums of the difference value for each channel corresponding to each pixel can be calculated and summed up within the local window to determine the average strength per pixel in D (so called difference image).

Fₜ therein corresponds to the current/second image and Gₜ₋₁ corresponds to the first image, wherein this image is an already filtered image. The pixel coordinates are described by i and j. The higher the value of a pixel, the more likely it is that the corresponding pixel position is marked as a non-stationary pixel. This decision is in particular made during the thresholding operation, wherein a pixel is marked as stationary if its value is lower than a threshold value for that pixel. The threshold value may either be a hard or a soft threshold value with one output for each pixel and with a value of between alpha and 1. The threshold value, however, is not constant for all pixels. The threshold value is determined in a threshold value determination block. The input for the threshold value determination block is a series of points that were computed by the feature capturing block. These points are important features in the image, such as corners, edges, or outlines of an object.

According to a further advantageous embodiment, for determining an association with the at least one feature a threshold value for a pixel environment/neighborhood of each pixel of the feature is determined. This threshold value may in particular be determined on the basis of an initial threshold value. In particular this threshold value is used to make the decision whether the pixel is a stationary pixel. This threshold value therein may either be a hard or a soft threshold value with a corresponding weighting output for each pixel and with a value between alpha and 1. The threshold value therein is not constant for every pixel. The threshold value is in particular determined in a so-called threshold value determination block. The input for the threshold value determination block is a series of points that were determined by the feature capturing block. These points represent important features in the image, such as for instance corners, edges, or outlines of an object.

Further, it has proven to be advantageous, if as pixel environment a round pixel window or a rectangular pixel window and/or an elliptic pixel window is predetermined. Thus, different “window shapes” for the pixel environment/neighborhood can be realized, whereby the threshold value may be reliably determined.

In a further advantageous embodiment the threshold value for each pixel is initially set to a constant threshold value to, which is determined by the estimated temporal noise in the image sequence. This initial value is modified separately for each pixel based on the proximity of its location to the coordinates of a feature point. In particular, a pixel threshold value of sigma * t₀ is set to all pixels within the local window whose center is marked by the point determined in the feature detection block. Alternatively, also a smooth transition from the average value sigma * t₀ to t₀ along the local region may be applied.

A further variant relates to the shape of the local window, such as circular, rectangular or elliptic depending on the aspect ratio of the image. Thus, different “window shapes” for the pixel environment/neighborhood can be realized, whereby the threshold value may be reliably determined.

It has further proven to be advantageous, if the threshold value of a pixel in a uniform region without a determined feature in the second image is set high and the threshold value of a pixel within the pixel environment/neighborhood of the determined feature point is set low. The use of a high threshold value in a uniform surface prevents that a pixel is marked as being in motion, even though it is a stationary pixel. The setting of a low threshold value, in particular of sigma * t₀, for the marked areas or for the features, reduces the probability of marking a pixel as a stationary pixel, even though it is a pixel in motion. Marking a pixel as a stationary pixel, even though it is a pixel in motion, leads to motion blur in the image. Marking a pixel as a non-stationary pixel, even though it is a stationary pixel, leads to visible temporary noise at uniform places in the image. By the approach of the adaptive motion detection presented here motion blur can be prevented.

The presented method is in particular a computer-implemented method. Therefore a further aspect of the invention relates to a computer program product with program code means, which, if the program code means are executed by the electronic computing unit, cause an electronic computing unit to perform a method according to the preceding aspect. The computer program product may also be referred to as computer program product.

Further, the invention also relates to a computer-readable storage medium comprising a computer program product according to the preceding aspect.

The invention also relates to an electronic computing device for an assistance system of a motor vehicle for reducing a temporal noise in an image sequence of a camera of the assistance system, the electronic computing device comprising at least one feature capturing module, comprising at least one adaptive motion estimation module and comprising a blending module, wherein the electronic computing device is configured for performing a method according to the preceding aspect. In particular the method is performed by the electronic computing device.

The electronic computing device comprises for instance processors, circuitry, in particular integrated circuits, as well as further electronic components in order to be able to perform corresponding method steps.

Further the invention also relates to an assistance system comprising an electronic computing device according to the preceding aspect.

The invention also relates to a motor vehicle comprising an assistance system according to the preceding aspect.

Advantageous embodiments of the method are to be regarded as advantageous embodiments of the computer program product, the computer-readable storage medium, the electronic computing device, the assistance system, as well as the motor vehicle. In particular the assistance system and the motor vehicle have device features for this purpose to be capable of performing corresponding method steps.

Further features of the invention are apparent from the claims, the figures and the figure description. The features and combinations of features mentioned above in the description as well as the features and combinations of features mentioned below in the description of figures and/or shown in the figures alone may comprise the invention not only in the respective combination stated, but also in other combinations, without leaving the scope of the invention. Thus, in particular, embodiments are to be regarded as comprised and disclosed by the invention, which are not explicitly shown and explained in the figures, however derive by separated feature combinations from the explained embodiments and can be generated therefrom. Also embodiments and combinations of features which thus do not have all features of an originally formulated independent claim are to be regarded as disclosed. Moreover, embodiments and feature combinations, in particular by the above explanations, are to be regarded as disclosed, which go beyond or deviate from the combinations of features set forth in the recitations of the claims may comprise the invention.

In the figures, the same elements or elements having the same function are equipped with the same reference signs.

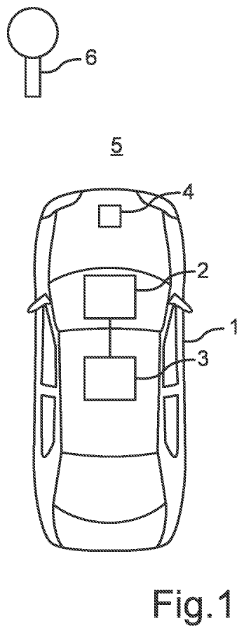

FIG. 1 shows a schematic top view of an embodiment of a motor vehicle 1 with an embodiment of an assistance system 2. The assistance system 2 comprises at least one electronic computing device 3 as well as a camera 4 for capturing an environment 5 of the motor vehicle 1.

Further in FIG. 1 a static object 6 is shown, which is represented in particular as a tree.

In particular in the following a method and an assistance system 2 for removing temporal noise in a video sequence of the camera 4 is shown. In particular a motion-adaptive method for temporal filtering is suggested. The pixels, which are in motion, are removed from superimposition/blending by an adaptive motion detector. The motion detector uses a target image, a previously filtered image and object features, in order to control the sensitivity of motion detection. The present invention reduces the temporal noise, in particular in poor light conditions, where the temporal noise in comparison with the real object features is high.

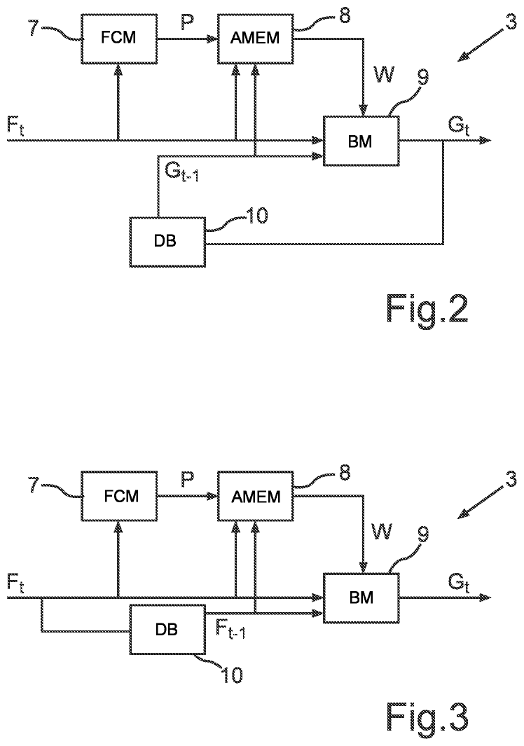

FIG. 2 shows a schematic block diagram according to an embodiment of the electronic computing device 3. In the present embodiment in particular a so-called recursive method is shown.

FIG. 2 in particular shows the method for reducing the temporal noise in the image sequence of the camera 4. The capturing of the first image Gₜ₋₁ of the image sequence of the environment 5 of the motor vehicle 1 is realized by the camera 4 at a first point in time t-1 and the capturing of a second image Fₜ of the image sequence of the environment 5 by the camera 4 at a second point in time t, which is later than the first point in time t-1. The determination of at least one feature in the second image Fₜ is effected by a feature capturing module 7 of the electronic computing device 3. The determination of at least one pixel associated with the at least one feature in the second image Fₜ is effected by the feature capturing module 7. The generating of a weighting map W for each pixel by an adaptive motion estimation module 8 of the electronic computing device 3 is effected. Then the reduction of the temporal noise by blending the pixels of the first image Gₜ₋₁, Fₜ₋₁ with pixels of the second image Fₜ is effected in dependence on the generated weighting map W by a blending module 9 of the electronic computing device 3.

In the present embodiment in particular thus a motion-adaptive temporal filtering is provided. The sensitivity of motion detection is improved by using a set of image features, P, which is determined for every second image Fₜ of the feature capturing module 7. In this connection there are two kinds of errors in the motion estimation phase. The first error is the marking of a pixel as stationary, even though it is a pixel in motion. These errors lead to a motion blur in the image. The second error is the marking of a pixel as pixel in motion, even though it is stationary. These errors lead to a visible temporary noise at uniform places in the image. The adaptive motion detection block described here, which in particular corresponds to the adaptive motion estimation module 8, mitigates the motion blur problem.

FIG. 2 therein shows in particular a functional block diagram of an embodiment of the invention. The suggested method or the suggested electronic computing device 3, respectively, therein are formed of the feature capturing module 7, the adaptive motion estimation module 8, as well as the blending module 9 for superimposition of the second image Fₜ, which is also referred to as target image, and the previously filtered image, which in the present exemplary embodiment corresponds to the first image Gₜ₋₁.

In FIG. 2 it is in particular shown that after the blending module the blended image Gₜ is generated. The blended image Gₜ, in turn, can be fed back via a delay block 10 as first blended image Gₜ₋₁.

In FIG. 3 a further electronic computing device according to the invention is shown, wherein in the present exemplary embodiment, in turn, a non-recursive method is suggested. In other words, the first image Fₜ₋₁ is generated as unfiltered first image Fₜ₋₁ via the delay block 10 and is fed to the blending block 9. Thus, the first image Fₜ₋₁ is provided as an unblended image Fₜ₋₁.

For both FIG. 2, recursive version, and FIG. 3, non-recursive version, the feature capturing module 7 therein generates the set of feature points P. The adaptive motion estimation module 8, in particular the so-called adaptive motion detector, in turn, generates the weighting map W, which is used for the superimposition or blending. The weighting map W consists of weighting values between alpha and 1. In this connection alpha marks a stationary pixel and 1 marks a moving image. These weightings are determined in the adaptive motion estimation module 8 on the basis of the pixel-by-pixel difference between the current and the previous image, that is in this exemplary embodiment the second image Fₜ and the first image Fₜ₋₁, and of the feature points computed in the feature capturing module 7. Herein, as a substantial aspect, the determining of a so-called threshold value for each pixel difference on the basis of the proximity of its coordinates to a feature point in P is to be mentioned.

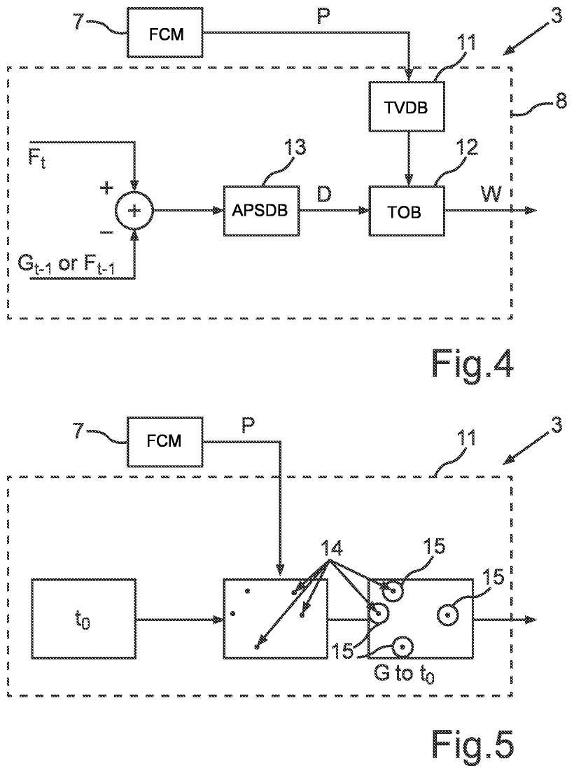

FIG. 4 again shows a part of the electronic computing device 3. In particular in the present exemplary embodiment a detailed view of the adaptive motion estimation module 8 is shown. In FIG. 4 thus in particular the steps for generating the weighting map W by using the feature points P and current (second) image Fₜ and the previous (first) image are shown. Herein in the present embodiment both the recursive method with the first/previous image Gₜ₋₁ as well as the second method with the non-recursive method and the first/previous image Fₜ₋₁ are shown. In FIG. 4 in particular a threshold value determination block 11, a threshold operator block 12, as well as an average pixel strength determination block 13 are shown. The pixel-by-pixel difference between the second image Fₜ and the previous image Gₜ₋₁, Fₜ₋₁ is generated. The average strength for each difference pixel is determined in a local window in the following equation:

$$D ( x , y ) = {\sum }_{i = - M}^{M} {\sum }_{j = - M}^{M} ‖ {F}_{t} ( x - i , y - j ) - {G}_{t - 1} ( x - i , y - j ) ‖$$

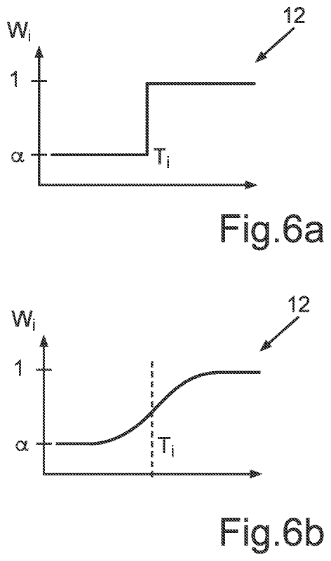

In particular in this formula the absolute difference and the sum of squares may be used to determine the average strength per pixel in D. Fₜ therein corresponds to the second/current image and Gₜ₋₁ corresponds to the first/previous image, wherein this image is an already filtered image. The pixel coordinates are described by i and j. The higher the value of a pixel in D, the more likely it is that the corresponding pixel position is marked as pixel in motion. This decision is in particular made in a threshold operator block 12. The threshold may either be a hard or a soft threshold value, as in particular shown in FIG. 6, wherein the output, in turn, is the weighting map W for each pixel and with a value of between alpha and 1. However, the threshold is not constant for all pixels. The threshold is determined in the threshold value determination block 11. The input for the threshold value determination block 11 is a series of points that have been determined by the feature capturing module 7. These points represent important features in the second image Ft, such as for instance corners, edges, or outlines of an object.

FIG. 5 shows a further embodiment of the electronic computing device 3, wherein in particular the threshold value determination block 11 is shown in more detail. The input for threshold determination block 11 is the coordinates of the feature points, P, in the image coordinate system. The output for the threshold determination block 11 is a threshold value map which shows the threshold values to be applied at each pixel location. The threshold value map is initialized by a constant threshold value, to, determined by the estimated temporal noise in the video. At the initial stage each pixel location of the threshold map has a value of to. Based on the pixel coordinates of the feature points P, a local window 15 with a center location given by each point pᵢ 14 in P is marked on the initial threshold map.

If the threshold value at a pixel location is set to a low value, there is a high chance that the pixel is labeled as a non-stationary pixel. In this case that pixel will not be included in blending which in return prevents motion blur. The core idea of this invention is to set a low threshold, on pixel location in the vicinity/neighborhood/environment 15 of a feature point P 14.

In one implementation, a threshold value of sigma * t₀ is set to the pixel window whereas a threshold value of t₀ is set for the rest of the locations, where sigma has a value between 0 and 1.

A further variant relates to the shape of the local window. Instead of a circular window, that is in particular the pixel environment 15, as it is represented in FIG. 5, also a rectangular or elliptic window, that is a rectangular or elliptic pixel environment 15, can be chosen, depending on the aspect ratio of the detector pixel.

FIG. 6a and FIG. 6b show diagrams for determining the threshold value. On FIG. 6a in particular a so-called hard threshold value is shown, which at the value Tᵢ jumps from alpha directly to 1, whilst FIG. 6b, in turn, a Sigmoid function is shown. The shown diagrams are in particular used in the threshold operator block 12. In the case of the hard threshold value in particular a weighting parameter is inserted, wherein the weighting parameter wᵢ may merely take two values, namely 1 or alpha. In the case of the Sigmoid function also corresponding values in between may be taken. Finally, then again the superimposition function or blending function, respectively, is effected on the basis of the equation:

Gₜ(i,j)=wᵢ·Fₜ(i,j)+(1−wᵢ)·Gₜ₋ᵢ(i,j)

In other words, if a pixel within close proximity of a feature point has a higher probability of being marked as a moving pixel. Thus, it is less likely to be blended with a corresponding pixel in a previous image, whereby an improved noise reduction in the video sequence can be performed.

It is done by updating the threshold value pixel by pixel within adaptive motion estimation module.

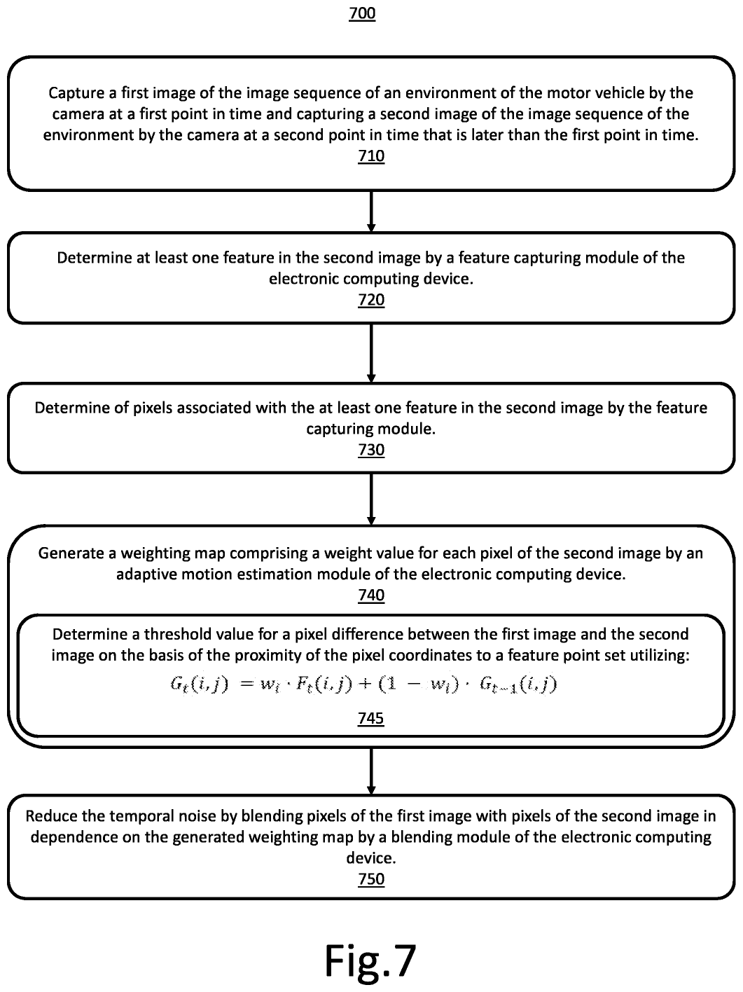

FIG. 7 illustratively shows and describes a method 700 for reducing a temporal noise in an image sequence by a camera of an assistance system of a motor vehicle by an electronic computing device of the assistance system. In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In block 710, capture a first image of the image sequence of an environment of the motor vehicle by the camera at a first point in time and capturing a second image of the image sequence of the environment by the camera at a second point in time that is later than the first point in time. In block 720, determine at least one feature in the second image by a feature capturing module of the electronic computing device. In block 730, determine of pixels associated with the at least one feature in the second image by the feature capturing module. In block 740, generate a weighting map comprising a weight value for each pixel of the second image by an adaptive motion estimation module of the electronic computing device. In block 745, determine a threshold value for a pixel difference between the first image and the second image on the basis of the proximity of the pixel coordinates to a feature point set utilizing:

Gₜ(i,j)=wᵢ·Fₜ(i,j)+(1−wᵢ)·Gₜ₋ᵢ(i,j)

In block 750, reduce the temporal noise by blending pixels of the first image with pixels of the second image in dependence on the generated weighting map by a blending module of the electronic computing device.

The methods, processes, or algorithms disclosed herein can be deliverable to or implemented by a processing device, controller, or computer, which can include any existing programmable electronic control unit or dedicated electronic control unit. Also, the methods, processes, or algorithms can be implemented in a software executable object. Furthermore, the methods, processes, or algorithms can be stored as data and instructions executable by a controller or computer in many forms including, but not limited to, information permanently stored on non-writable storage media, such as ROM devices, and information alterably stored on writeable storage media, such as floppy disks, magnetic tapes, CDs, RAM devices, and other magnetic and optical media. Computing devices described herein generally include computer-executable instructions, where the instructions may be executable by one or more computing or hardware devices, such as those listed above. Such instructions and other data may be stored and transmitted using a variety of computer-readable media. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions (e.g., from a memory, a computer-readable medium, etc.) and executes these instructions, thereby performing one or more processes, including one or more of the processes described herein. Moreover, the methods, processes, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims of the invention. While the present disclosure is described with reference to the figures, it will be understood by those skilled in the art that various changes may be made and equivalents may be substituted without departing from the scope and spirit of the present disclosure. The words used in the specification are words of description rather than limitation, and it is further understood that various changes may be made without departing from the scope and spirit of the invention disclosure. In addition, various modifications may be applied to adapt the teachings of the present disclosure to particular situations, applications, and/or materials, without departing from the essential scope and spirit thereof. Additionally, the features of various embodiments can be combined to form further embodiments of the invention that may not be explicitly described or illustrated. While various embodiments may have been described as providing advantages or being preferred over other embodiments or prior art implementations with respect to one or more desired characteristics, those of ordinary skill in the art recognize that one or more features or characteristics could be compromised to achieve desired overall system attributes, which depend on the specific application and implementation. These attributes can include, but not limited to, strength, cost, durability, life cycle cost, appearance, marketability, size, packaging, weight, serviceability, manufacturability, case of assembly, etc. Therefore, to the extent any embodiments are described as less desirable than other embodiments or prior art implementations with respect to one or more characteristics, these embodiments are not outside the scope of the disclosure and can be desirable for particular applications. Thus, the present disclosure is thus not limited to the particular examples disclosed herein, but includes all embodiments falling within the scope of the appended claims.

1. A method for reducing a temporal noise in an image sequence by a camera of an assistance system of a motor vehicle by an electronic computing device of the assistance system, comprising:
capturing a first image of the image sequence of an environment of the motor vehicle by the camera at a first point in time and capturing a second image of the image sequence of the environment by the camera at a second point in time that is later than the first point in time;
determining at least one feature in the second image by a feature capturing module of the electronic computing device;
determining of pixels associated with the at least one feature in the second image by the feature capturing module;
generating a weighting map comprising a weight value for each pixel of the second image by an adaptive motion estimation module of the electronic computing device; and
reducing the temporal noise by blending pixels of the first image with pixels of the second image in dependence on the generated weighting map by a blending module of the electronic computing device.

2. The method according to claim 1, wherein the pixels, which are determined to be stationary, in the second image are blended.

3. The method according to claim 1, wherein the lower the weighting of a pixel is determined, the higher a blending of this pixel with the corresponding pixel in the first image is performed.

4. The method according to claim 1, wherein the first image is blended with a further image already taken before the first image.

5. The method according to claim 1, wherein the first image is provided as an unblended image.

6. The method according to claim 1, wherein the at least one feature is determined on the basis of a corner search in the second image.

7. The method according to claim 1, wherein the weight value is responsive to a determined motion based on a subtraction of the first image from the second image.

8. The method according to claim 1, wherein determining of pixels includes determining a threshold value for a pixel environment of each pixel of the at least one feature.

9. The method according to claim 8, wherein the pixel environment is at least one of a round pixel window, a rectangular pixel window, or an elliptic pixel window.

10. The method according to claim 8, wherein the threshold value is determined responsive to an initial threshold value.

11. The method according to claim 8, wherein the threshold value in a uniform region without determined feature in the second image is set high and the threshold value in the pixel environment of the determined feature is set low.

12. The method according to claim 1, wherein generating the weighting map includes determining a threshold value for a pixel difference between the first image and the second image on the basis of the proximity of the pixel coordinates to a feature point set utilizing:
Gₜ(i,j)=wᵢ·Fₜ(i,j)+(1−wᵢ)·Gₜ₋ᵢ(i,j)
wherein i and j are the pixel coordinates;
wherein Gₜ is the blended image;
wherein wᵢ is a weighting parameter;
wherein Fₜ is the second image; and
wherein Gₜ₋₁ is the first image.

13. The method according to claim 12, wherein the pixel found within close proximity of the feature point is marked as a moving pixel and is not blended.

14. The method according to claim 12, wherein determining the threshold value utilizes a series of points that have been determined by the feature capturing module.

15. A computer-readable storage medium comprising a computer program product with a computer program, which, when the program code is executed by an electronic computing device, the electronic computing device performs a method for reducing a temporal noise in an image sequence by a camera of an assistance system of a motor vehicle by an electronic computing device of the assistance system, comprising:
capturing a first image of the image sequence of an environment of the motor vehicle by the camera at a first point in time and capturing a second image of the image sequence of the environment by the camera at a second point in time that is later than the first point in time;
determining at least one feature in the second image by a feature capturing module of the electronic computing device;
determining of pixels associated with the at least one feature in the second image by the feature capturing module;
generating a weighting map comprising a weight value for each pixel of the second image by an adaptive motion estimation module of the electronic computing device; and
reducing the temporal noise by blending pixels of the first image with pixels of the second image in dependence on the generated weighting map by a blending module of the electronic computing device.

16. The computer-readable storage medium according to claim 15, wherein the first image is provided as an unblended image.

17. The computer-readable storage medium according to claim 15, wherein the at least one feature is determined on the basis of a corner search in the second image.

18. An assistance system of a motor vehicle for reducing a temporal noise in an image sequence, comprising:
a camera;
an electronic computing device, with the electronic computing device including at least one feature capturing module, at least one adaptive motion estimation module, and at least one blending module, wherein the electronic computing device is configured to:
capture a first image of the image sequence of an environment of the motor vehicle by the camera at a first point in time and capturing a second image of the image sequence of the environment by the camera at a second point in time that is later than the first point in time;
determine at least one feature in the second image by the at least one feature capturing module;
determine of pixels associated with the at least one feature in the second image by the at least one feature capturing module;
generate a weighting map comprising a weight value for each pixel of the second image by the at least one adaptive motion estimation module; and
reduce the temporal noise by blending pixels of the first image with pixels of the second image in dependence on the generated weighting map by the at least one blending module.

19. The assistance system according to claim 18, wherein the weight value is responsive to a determined motion based on a subtraction of the first image from the second image.

20. The assistance system according to claim 18, wherein a threshold value for a pixel environment of each pixel of the at least one feature is determined.
